(19) United States
(12) Patent Application Publication
(10) Pub. No.: US 2005/0268244 A1
(43) Pub. Date: Dec. 1, 2005

(54) Method and system to provide direct access to subviews

(76) Inventor: Peter Vignet, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/857,692

(22) Filed: May 28, 2004

(51) Int. Cl. G06F 17/00

(52) U.S. Cl. 715/760; 715/810; 715/809

(57) ABSTRACT

A method and system a method and system to provide direct access to subviews are disclosed. A subview may be utilized to provide a user with details of a particular aspect of a service. A direct access to a subview is provided to achieve more efficient navigation. In order to invoke directly a subview that requires one or more parameters, a user may be presented with a selection from the list of acceptable values for each of the required parameters. Once the user makes a selection indicating the values for the required parameters, the associated subview may be invoked.

### FIELD OF THE INVENTION

An embodiment relates generally to enterprise resource and program management, and more particularly to a method and system to provide direct access to subviews.

### BACKGROUND OF THE INVENTION

Software applications in the field of enterprise resource and program management attempt to integrate all facets of a business including planning, manufacturing, sales, and marketing. As resource and program management methodology has become more popular, software applications have emerged to help business managers implement resource and program management in business activities to provide visibility into the entire portfolio of enterprise programs and projects, while supporting strategic capacity planning and resource allocation based on up-to-date information on skills and availability of the resources. It is desirable that an enterprise resource and program management tool be capable of leveraging data from base systems without disruption, and can be delivered at an effective and predictable cost.

A resource and program management system may enable users to manage and execute complex information technology (IT) and research and development (R&D) projects. Such system may, for example, integrate information from existing project management, human resources, financial, and time-tracking systems in order to provide a complete overview of a project portfolio.

### SUMMARY OF THE INVENTION

A method and system to provide direct access to subviews in an enterprise resource and program management environment.

According to one aspect, the system to provide direct access to subviews in an enterprise resource and program management environment includes an extractor to receive a selection of a subview from a user, the subview having a required parameter; a display module to present the user with a selection of a value for the required parameter; and a subview generator to generate the subview according to at least the selection of the value for the required parameter. The display module is to present the user with a first drop down list box, the first drop down list box populated with the selection of the subview utilizing a first drop down list box.

According to another aspect, the system further includes a dynamic page component to automatically populate the first drop down list box with a list of available subviews, the list of available subviews including the selection of the subview.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a network diagram depicting a system having a client-server architecture, according to one embodiment of the present invention;

FIG. 2 is an illustration of the structures of some of the tables utilized by the system, according to one embodiment of the present invention;

FIG. 3 is a block diagram illustrating a system to provide direct access to subviews in an enterprise resource and program management environment, according to one embodiment of the present invention;

FIG. 4 is a flow diagram illustrating a method to provide direct access to subviews in an enterprise resource and program management environment, according to one embodiment of the present invention;

FIG. 4A is a diagrammatic representation of some user interface elements utilized by the system to provide direct access to subviews in an enterprise resource and program management environment, according to one embodiment of the present invention;

FIG. 5 is a diagrammatic representation of dataflow of a dynamic page component, according to one embodiment of the present invention;

FIG. 5A is an implementation example of a reusable software component as a Java Bean, according to one embodiment of the present invention; and

FIG. 6 is a diagrammatic representation of a computer system, within which a set of instructions, for causing the machine to perform any one or more of the methodologies discussed herein, may be executed.

### DETAILED DESCRIPTION

A method and system to provide direct access to subviews in an enterprise resource and program management environment are disclosed. In the following description, for purposes of explanation, numerous specific details are set forth in order to provide a thorough understanding of the present invention. It will be evident, however, to one skilled in the art that the present invention may be practiced without these specific details.

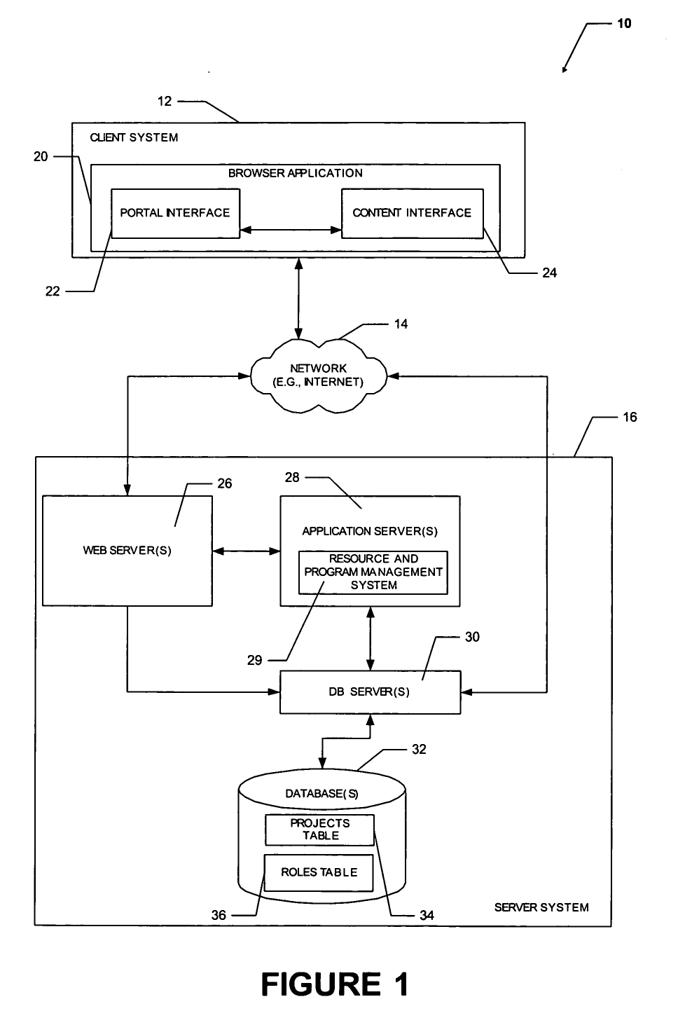

FIG. 1 is a network diagram depicting a system 10, according to one exemplary embodiment of the present invention, having client-server architecture. A client system 12 is coupled via a network 14 (e.g., the Internet or an intranet) to a server system 16, so as to facilitate communications (e.g., utilizing any one of a number of well-known network communication protocols, such as HTTP) between the client system 12 and the server system 16. In FIG. 1, the client 12 may be any computing device, including a laptop computer, notebook computer, personal digital assistant (PDA), or handheld wireless phone. The client system 12 may further host a number of client applications, such as a browser application 20 (e.g., MS EXPLORER®, developed by Microsoft Corporation of Redmond, of Washington State). The browser application 20 may include a portal interface 22 and a content interface 24.

In one exemplary embodiment, the portal interface 22 may facilitate user access to one or more applications hosted on the application server 28, such as employee self service application.

The portal interface 22 is shown to invoke the content interface 24 within which content associated with a web-based application may be presented to a user. Specifically, the content interface 24 may communicate with the one or more applications hosted on the application server 28, at least one of which may be responsible for the delivery of content to the content interface 24. Both the portal interface 22 and the content interface 24 may communicate with the server system 16 via the network 14.

The server system 16, in one exemplary embodiment, may include a web server 26, an application server 28, and a database (DB) server 30. The database server 30 may be connected a database 32. The application server 28 may be deployed to support one or more applications, and may utilize the database server 30 to store and to retrieve data from a database 32. The database 30 may, for example, store data such as project information in an exemplary form of projects table 34, and other information. The data within the database 32 may be stored in any one of a number of forms, such as, for example, flat files, relational tables objects, or as XML (extensible Markup Language) data structures. The application servers 28 may also be coupled to one or more web servers 26, so as to facilitate the delivery of web content, including content containing embedded code, such as Java, to the portal interface 22 and the content interface 24. In one embodiment, a resource and program management system 29 resides on the application server 28.

Resource and program management systems may be utilized, for example, to allow a user to navigate among services, to view services, and to edit data within services. A service may be presented to a user as a view. For some services, a user may be able to access a main service view, as well as one or more service subviews. It will be noted that a subview may include any view that is accessible from another view. For example, if a user can invoke an “Edit Project” view by clicking the “Edit Project” button in a “Project” view, then the “Edit Project” view may be termed a subview.

In a resource and program management system, a project subview may be utilized to provide a user with details of a particular aspect of the project, or, for example, to allow a user to edit project data. For instance, a user may be able to access a subview that enables the user to assign tasks to project roles. Navigating to a frequently used subview in a resource and program management system may require navigation through several intermediate subviews.

In one existing resource and program management system, a user is first presented with a main view (e.g., a projects dash board). An operation of assigning a task to a project role may be accomplished from an “Assign Tasks to Project Role” subview. Thus, in order to access this subview from the projects dashboard, a project manager who wants to assign a task to a project role, must access the “Assign Tasks to Project Role” subview.

In order to access the “Assign Tasks to Project Role” subview, a number of steps may be necessary. When the project dashboard appears, the user selects a desired project. Once the project is selected, another view, the project details subview, and the project information menu appear. From the project information menu, the user may select a “roles list view” item. The roles list subview appears responsive to the user's selection, and the user may select a role from the roles list. Once a role is selected, the role details subview appears. The role details subview may have a control button to allow the user to access an “Assign tasks to role” subview. The user is presented with the “Assign tasks to role” subview once the user activates the control button. Thus, in order to access the “Assign task to a project role”, a user has to pass through four different subviews (in this example, projects list, project details menu, roles list, and roles details).

At each of the subviews, the resource and program management system receives required parameters for each consecutive subview. In one embodiment, subviews may be invoked utilizing universal resource identifier (URI) parameters (e.g., URI?param1=123&param2=456). In the example above, a user is guided through four different subviews in order to ensure that a desired subview (e.g., the “Assign task to a project role” subview) is invoked with correct parameters. By accessing each intermittent subview, a user is forced to select the parameters required to invoke the desired subview. In the example given above, the parameters to invoke the “Assign task to project role” subview requires two parameters: project identification (projectID) and role identification (roleID). A project ID is selected when the end user selects the project from the project list. A roleID is selected when the user selects a role from the role list.

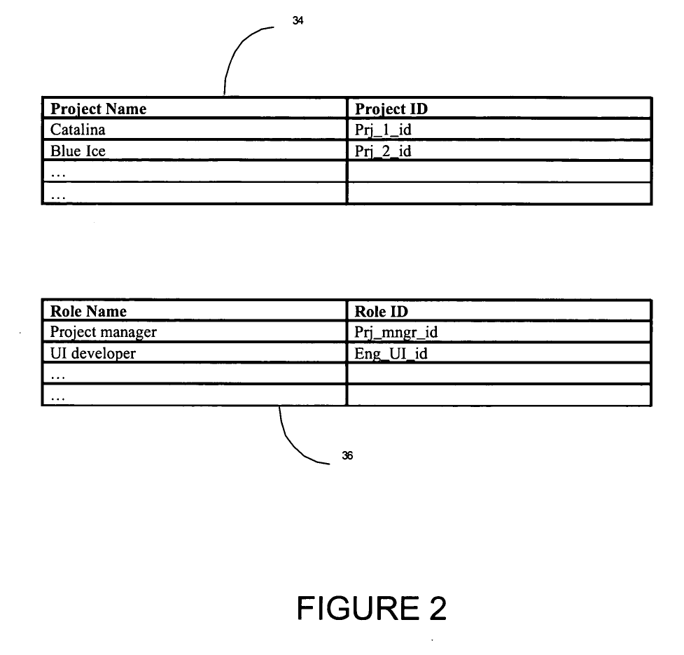

FIG. 2 is an illustration of the structures of some of the tables utilized by the resource and program management system 29, according to one embodiment of the present invention. The projects table 34 includes the values for projects' names and the corresponding values for projects' technical names (e.g., project ID values). The views table 36 includes the values for views' names and the corresponding values for roles' technical names (e.g., role ID values).

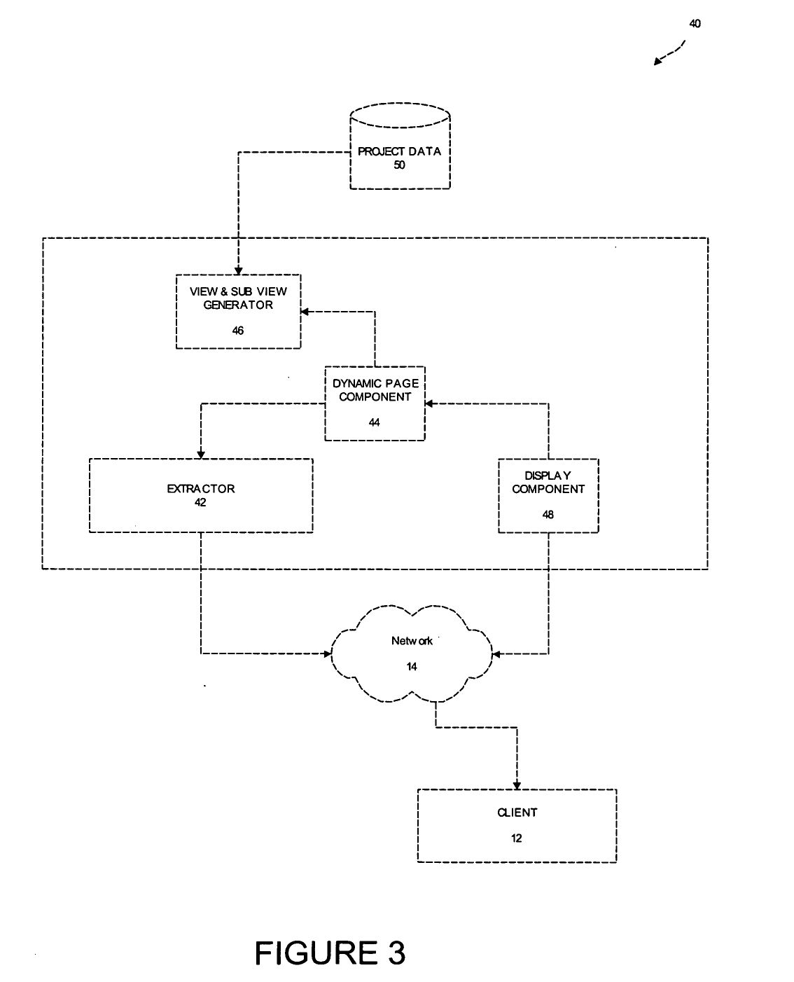

FIG. 3 is a block diagram illustrating a system 40 to provide direct access to subviews in an enterprise resource and program management environment, according to one embodiment of the present invention, having client-server architecture. A business platform, in the exemplary form of the network-based resource and project management system 29, provides server-side functionality, via the network 14 (e.g., the Internet) to the one or more clients 12. The resource and project management system 29 may be configured to provide a number of business management functions and services to users.

The system 40 allows the client 12 to request and receive a direct access to subviews in an enterprise resource and program management environment. The resource and project management system 29 may include an extractor 42, dynamic page components 44, view & subview generators 46, and a display component 48. The extractor 42 may be configured to receive a client's request for a desired subview. The subview may include a view representing information related to a particular project. The project data may be stored in a project database 50. The project database 50 may be, in one embodiment, a database from the databases 32. The dynamic page component 44 may be configured to receive a request for a subview from the extractor 42 and to provide information related to the request to the view & subview generator 46. The dynamic page component 44 may be configured to generate dynamic web pages representing requested subviews and provide them to the display component 48.

In one exemplary embodiment, the system 40 is configured to provide direct access to a subview (e.g., to the “Assign task to a project role” view in the example above) in order to offer more efficient navigation to a user. In order to invoke directly a subview that requires one or more parameters (such as, for example, a subview that requires a project name and a role identification), a user may be presented with a selection from the list of acceptable values for the required parameters. Once the user makes a selection from the list of acceptable values, the associated subview may be invoked.

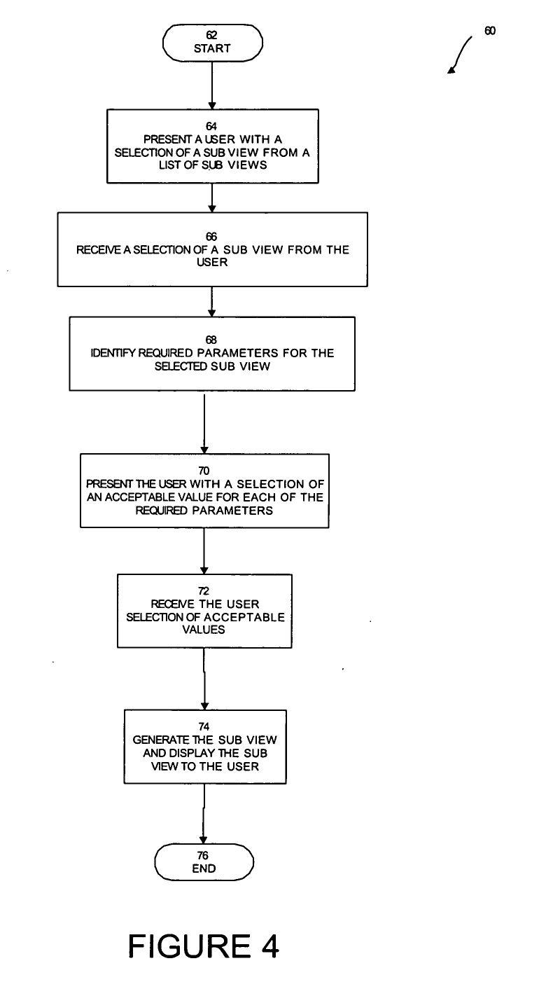

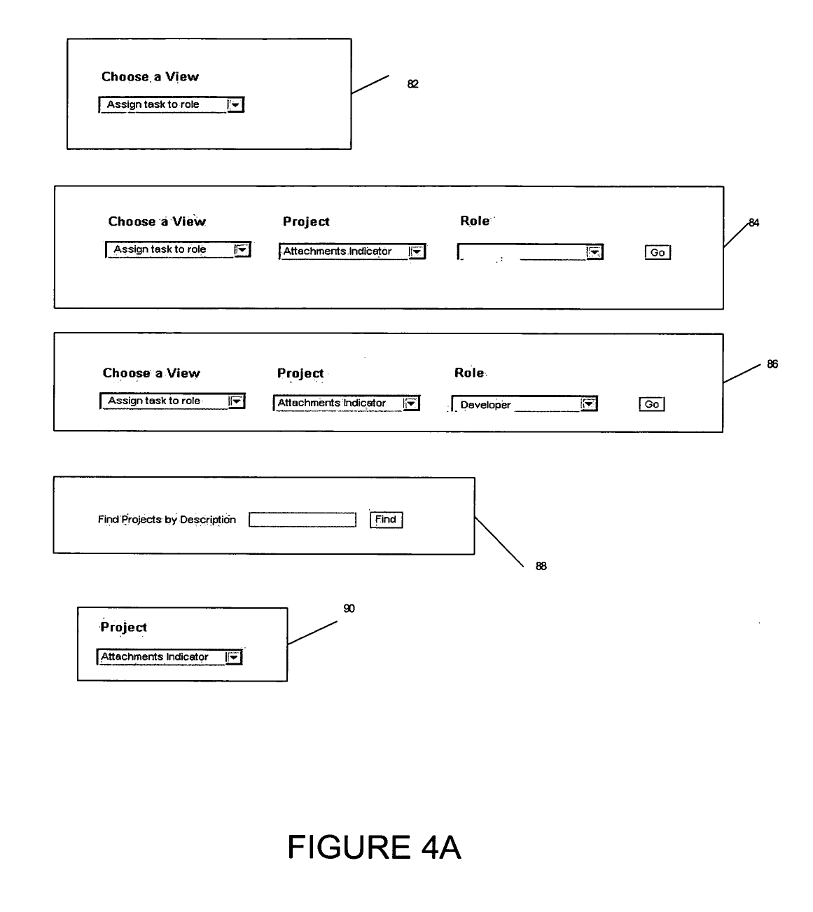

FIG. 4 is a flow chart illustrating a method 60 to provide direct access to subviews in an enterprise resource and program management environment, according to one embodiment of the present invention. The method 60 commences at operation 62. At operation 64, a user is presented with a selection of a subview from a list of subviews (e.g., a list of projects). In one embodiment, a user may be presented with a drop down list box populated with available subviews, as illustrated in FIG. 4A, item 82. At operation 66 the extractor 42 receives a selection of a subview and communicates the selection to the dynamic page component 44. The dynamic page component 44 communicates the selection to the subview generator 46. The subview generator 46 identifies required parameters for the subview at operation 68, and communicates a list of acceptable values for the required parameters to the user utilizing the display component 48. The user is presented with a selection of an acceptable value for each of the required parameters at operation 70. For example, the view “Assign Task to Project Role” requires two parameters, projectID and roleID. When a user selects the “Assign Task to Project Role” subview, the user is presented with two dropdown list boxes, a “Project” dropdown list box and a “Role” dropdown list box, as illustrated in item 84 in FIG. 4A. The “Project” dropdown list box displays the project names, where each project name has an associated hidden key (e.g., projectID). Once a user selects the project (e.g., the “Attachments Indicator” project, as illustrated in item 84 in FIG. 4A), the “Role” dropdown list box is automatically populated with acceptable roleID values. The “Roles” dropdown list box displays the roles names (item 86 of FIG. 4A), where each roles name has an associated hidden key (e.g., roleID). The hidden keys may be stored in a table, such as, for example, the projects table 34 and the roles table 36 of FIG. 2.

At operation 72 the extractor 42 receives the user selection of the values for the required parameter. The user selection may be effectuated by the user selecting a value in each of the presented drop down list boxes and clicking on the “GO” button, as illustrated in item 86 of FIG. 4A. The requested subview is generated by the subview generator 46 and communicated to the user by the display component 48.

In the example given, the desired the subview (the “Assign Task to Project Role” subview) is accessed directly from the projects dashboard. Thus, a user is enabled to specify the desired subview and the values for the required parameters without navigating through several intermediate subviews.

In an alternative embodiment, a user may be presented with a search box instead of (or in addition to) a dropdown list box, as illustrated in items 88 and 90 of FIG. 4A.

Returning to FIG. 2, the resource and project management system 29 may provide business management tools to a user, such as resource and project management. The system 29 may utilize information related, for example, to projects and projects' schedules stored in the project database 50 in order to present subviews to the user. It is desirable to provide the user with a GUI that allows the user to select a desired subview and a selection of acceptable values for the required parameters.

The HTML-Business for Java (HTMLB) controls may be necessary to create a proper graphical user interface (GUI). HTMLB allows creating a design-oriented page layout. HTMLB may provide a user with a set of controls. The controls may be based, for example, on servlets and Java Server Pages (JSP) pages. A developer may use bean-like components or JSP tags. Renderer classes may be utilized to translate various components into HTML commands.

In addition to creating a proper GUI, a web application may need appropriate event handling to fill the application with live feed. There may be a number of controls that generate events. Java Server Pages (JSP) technology provides a simplified, fast way to create web pages that display dynamically generated content. The basic event handling occurs on the JSP level. The dynamic page component 18 may be used for enhanced event handling and easy session management. The dynamic page component 18, in one embodiment, uses the Business HTML for Java as API to design the GUI and handles the data and event transfer.

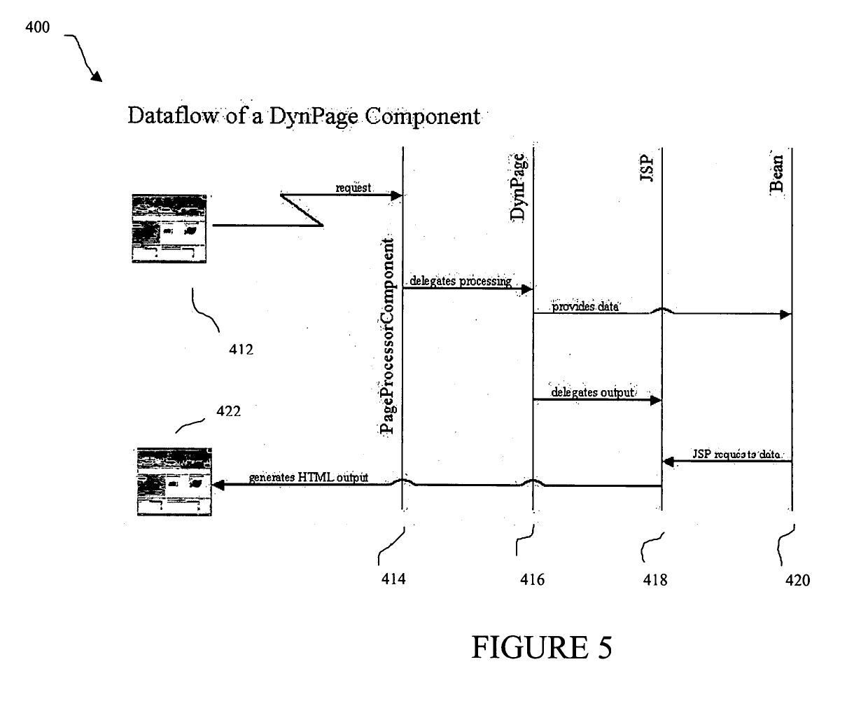

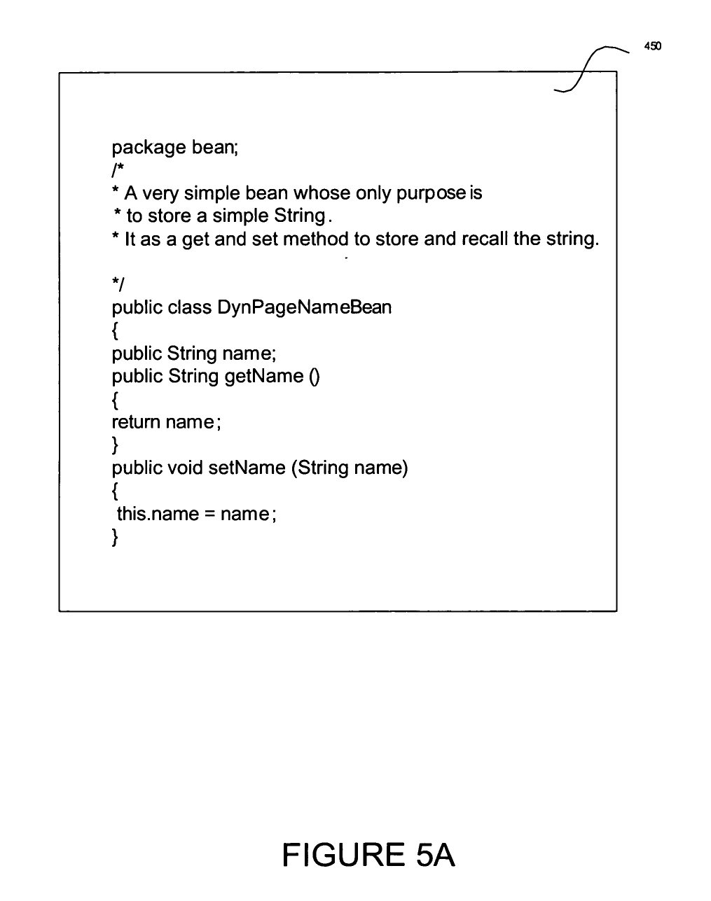

FIG. 5 is a diagrammatic representation of dataflow of the dynamic page component 18, according to one embodiment of the present invention. In FIG. 5, a request from a web page 412 is received at the page processor component 414. The page processor component 414, in one exemplary embodiment, corresponds to the extractor 42 of FIG. 2. The page processor component 414 delegates the request processing to a dynamic page component 416. The dynamic page component 416, in one exemplary embodiment, corresponds to the dynamic page component 44 of FIG. 2. The exchange of data between the dynamic page component 416 and a JSP program 418 occurs by using a reusable software component 420. The reusable software component 420, in one exemplary embodiment, corresponds to the subview generator 46 of FIG. 2, and may be implemented as a Java Bean. FIG. 5A is an implementation example 450 of the reusable software component 420 as a Java Bean.

The reusable software component 420 may be used to get and set “dynamic” data. The dynamic page component 416 may provide the reusable software component 420 with project data; and the JSP program 418 may read the project data. For example a user input may be stored in the reusable software component 420 and than displayed as text by the JSP program 418. Thus, the dynamic page component 416 may provide data associated with a request from the web page 412 to a reusable software component 420 (e.g., the table view component 24). The dynamic page component 416 may delegate generation of an output to the JSP program 418. The reusable software component 420 provides the requested data to the JSP program 418. Finally, the JSP program 418 generates HTML output resulting in a web page 422.

It will be noted that the exchange of data between the dynamic page component 416 and a JSP program 418 may also be effectuated utilizing a session object, a context object, or a request object.

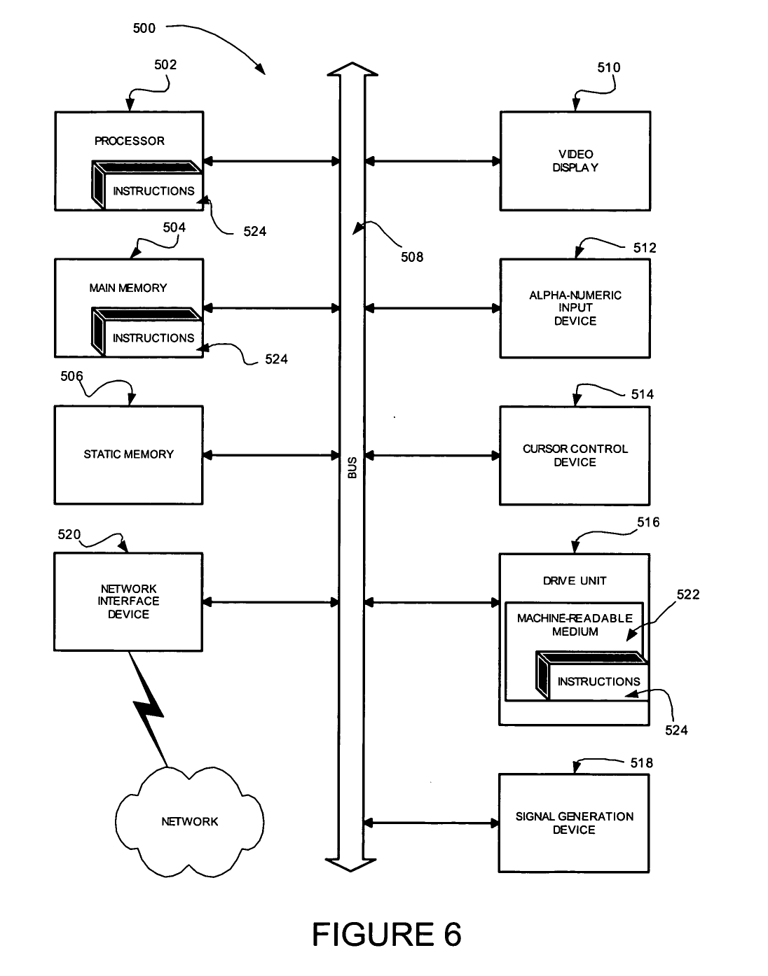

FIG. 6 illustrates a diagrammatic representation of machine in the exemplary form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processor 502 (e.g., a central processing unit (CPU) a graphics processing unit (GPU) or both), a main memory 504, and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions (e.g., software 524) embodying any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media. The software 524 may further be transmitted or received over a network 526 via the network interface device 520.

While the machine-readable medium 522 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to provide direct access to subviews in an enterprise resource and program management environment have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A system to navigate a web service, the system including:
an extractor to receive a selection of a subview from a user, the subview having a required parameter;
a display module to present the user with a selection of a value for the required parameter; and
a subview generator to generate the subview according to at least the selection of the value for the required parameter.

2. The system of claim 1, wherein the display module is to present the user with a first drop down list box, the first drop down list box populated with the selection of the subview utilizing a first drop down list box.

3. The system of claim 2, including a dynamic page component to automatically populate the first drop down list box with a list of available subviews, the list of available subviews including the selection of the subview.

4. The system of claim 1, wherein the display module is to present the user with a subview search box.

5. The system of claim 1, wherein the value for the required parameter is one value from a plurality of acceptable values.

6. The system of claim 1, wherein the display module is to present the user with a second drop down list box, the second drop down list box populated with the selection of the value for the required parameter utilizing a first drop down list box.

7. The system of claim 6, wherein the dynamic page component is to automatically populate the second drop down list box with a list of acceptable values for the required parameter.

8. The system of claim 7, wherein the subview generator is to identify the required parameter associated with the subview.

9. The system of claim 1, wherein the subview is associated with a main view.

10. The system of claim 1, wherein the subview is an HTML page.

11. A method to navigate a web service, the method including:
receiving, from a user, a selection of a subview, the subview having a required parameter;
presenting the user with a selection of a value for the required parameter; and
generating the subview according to at least the selection of the value for the required parameter.

12. The method of claim 1, wherein the receiving of the selection of the subview includes presenting the user with the selection of the subview, the presenting utilizing a first drop down list box.

13. The method of claim 12, wherein the presenting the user with the selection of the subview includes automatically populating the first drop down list box with a list of available subviews.

14. The method of claim 12, wherein the presenting of the user with the selection of the subview is effectuated utilizing a subview search box.

15. The method of claim 11, wherein the value for the required parameter is one value from a plurality of acceptable values.

16. The method of claim 11, wherein the presenting of the user with the selection of the value for the required parameter is effectuated utilizing a second drop down list box.

17. The method of claim 16, wherein the presenting of the user with the selection of the value for the required parameter includes automatically populating the second drop down list box with a list of acceptable values for the required parameter.

18. The method of claim 11, wherein presenting the user with a selection of the value for the required parameter includes identifying the required parameter associated with the subview.

19. The method of claim 11, wherein the generating of the subview includes accessing the subview.

20. The method of claim 11, wherein the subview is associated with a main view.

21. A system to navigate a web service, the system including:
means for receiving a selection of a subview from a user, the subview having a required parameter;
means for presenting the user with a selection of a value for the required parameter; and
means for generating the subview according to at least the selection of the value for the required parameter.

22. A machine-readable medium having stored thereon data representing sets of instructions which, when executed by a machine, cause the machine to:
receive a selection of a subview from a user, the subview having a required parameter;
present the user with a selection of a value for the required parameter; and generate the subview according to at least the selection of the value for the required parameter.
